(19) United States
(12) Patent Application Publication
(10) Pub. No.: US 2026/0310357 A1
(43) Pub. Date: Oct. 8, 2026

(54) MITIGATING EFFECTS OF A LINE RESET IN A FLASH MEMORY INTERFACE

(71) Applicant: Qualcomm Incorporated, San Diego, CA (US)

(72) Inventors: Asutosh DAS, San Diego, CA (US); Can GUO, Shanghai (CN)

(21) Appl. No.: 19/482,764

(22) PCT Filed: May 17, 2023
(86) PCT No.: PCT/CN2023/094731

§ 371 Date: Nov. 9, 2025

(51) Int. Cl. G06F 3/06

(52) U.S. Cl. CPC G06F 3/0619; G06F 3/0634; G06F 3/0679

(57) ABSTRACT

An effect of a line reset occurring during a power mode change in a UFS memory system may be mitigated. A UFS memory device may receive a low-power mode request from a host device. The UFS memory device may also receive a reset request. The UFS memory device may enter the low-power mode in response to the low-power mode request. The UFS memory device may provide an indication of an exception event to the host device when the reset request is received and the memory device enters the low-power mode.

### DESCRIPTION OF THE RELATED ART

Universal Flash Storage (“UFS”) is a non-volatile memory system that may be employed in computing devices, such as desktop and laptop computers, tablet computers, mobile phones, etc. UFS is a type of managed flash memory, meaning that a UFS device includes not only the flash data storage elements but also a flash memory controller. The UFS standard is maintained by the Joint Electron Device Engineering Council (“JEDEC”) and relies on transport-layer and physical-layer protocols and interfaces known as M-PHY® and UNIPRO® provided by the Mobile Industry Processor Interface (“MIPI”) Alliance. The UFS command set borrows from the Small Computer System Interface (“SCSI”) command set. A UFS device may communicate with a host device over a serial data link that is used for both commands and data. The serial data link may comprise multiple (e.g., two) lanes. Advantages of UFS may include high speed and low power consumption.

A feature of UFS enables dynamic selection of data link power and speed modes. Some versions of UFS provide a range of selectable speed modes, including low-speed (“LS”) and high-speed (“HS”) modes. Some versions of UFS provide selectable high-speed modes, referred to as “gears,” ranging from “HS-G1” to, for example, “HS-G5.” Another feature of UFS enables selection of a power mode or state. For example, one or more of a sleep state, a stall state, and a hibernate state (commonly referred to as “hibern8”) may be provided in which the UFS device is less active or inactive and conserving power.

The host device may send a request (i.e., a data packet containing information indicating the request) to change the power mode to the UFS device. The UFS device may receive the power mode request and determine whether it can change its power mode as requested. If the UFS changes its power mode in response to the request, the UFS device may send a confirmation (i.e., a data packet containing information indicating the confirmation) back to the host.

A UFS device may fail to properly receive a request from the host device to change the power mode, due to, for example, a signaling anomaly on the data link. A host device may re-send a request to the UFS device if the host does not receive a confirmation within a timeout period. The host device may send a line reset to the UFS device before re-trying the request to change the power mode. It would be desirable to improve the manner in which such events are handled.

### SUMMARY OF THE DISCLOSURE

Systems, methods, devices, and other examples are disclosed for mitigating effects of a line reset in a memory system.

An exemplary method for mitigating an effect of a line reset may include receiving, by a memory device, a low-power mode request from a host device. The method may also include receiving, by the memory device, a reset request. The method may further include entering, by the memory device, the low-power mode in response to the low-power mode request. The method may still further include providing, by the memory device, an indication of an exception event in response to the memory device receiving the reset request and the low-power mode request and the memory device entering the low-power mode.

A system for mitigating an effect of a line reset in a memory system may include a host device and a memory device. The memory device may be configured to receive a low-power mode request from the host device. The memory device may also be configured to receive a reset request from the host device. The memory device may further be configured to enter the low-power mode in response to the low-power mode request. The memory device may still further be configured to provide an indication of an exception event in response to the memory device receiving the reset request and the low-power mode request and the memory device entering the low-power mode.

A system for mitigating an effect of a line reset in a memory system may include means for receiving a low-power mode request from a host device. The system may also include means for receiving a reset request from the host device. The system may further include means for entering the low-power mode in response to the low-power mode request. The system may still further include means for providing an indication of an exception event in response to receiving the reset request and the low-power mode request and entering the low-power mode.

A Universal Flash System (“UFS”) memory device may include a flash memory storage array and a UFS controller. The UFS controller may be configured to receive a low-power mode request from a host device. The UFS controller may also be configured to receive a reset request from the host device. The UFS controller may further be configured to enter the low-power mode in response to the low-power mode request. The UFS controller may still further be configured to provide an indication of an exception event in response to the memory device receiving the reset request and the low-power mode request and the memory device entering the low-power mode.

### BRIEF DESCRIPTION OF THE DRAWINGS

In the Figures, like reference numerals refer to like parts throughout the various views unless otherwise indicated. For reference numerals with letter character designations such as “101A” or “101B”, the letter character designations may differentiate two like parts or elements present in the same Figure. Letter character designations for reference numerals may be omitted when it is intended that a reference numeral encompass all parts having the same reference numeral in all Figures.

FIG. 1 is a block diagram of a device having features for mitigating effects of a line reset in a UFS memory system, in accordance with exemplary embodiments.

FIG. 2 is a block diagram of a system having local and remote UFS features, in accordance with exemplary embodiments.

FIG. 3A is a communication sequence diagram illustrating a problem in conventional UFS systems and methods.

FIG. 3B is a continuation of FIG. 3A.

FIGS. 4A and 4B are communication sequence diagram illustrating an example of a solution to the problem illustrated in FIGS. 3A-3B, in accordance with exemplary embodiments.

FIG. 5 is a portion of a UFS attribute table, in accordance with exemplary embodiments.

FIG. 6 is a flow diagram indicating a method for mitigating effects of a line reset in a memory system, in accordance with exemplary embodiments.

FIG. 7 is a flow diagram indicating another method for mitigating effects of a line reset in a memory system, in accordance with exemplary embodiments.

FIG. 8 is block diagram of a portable computing device having, among other features, a UFS memory system, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

The term “UFS” is used herein to refer to a family of storage access and transport protocols promulgated by JEDEC, an industry consortium. An example of one such protocol is UFS Version 4.0 (published as JESD220F UFS 4.0). UFS may use a UFS physical-layer interface known as M-PHY®. The UFS Version 4.0 protocol may incorporate or reference protocols promulgated by the Mobile Industry Processor Interface (“MIPI”) Alliance. UFS version 4.0, for example, references the MIPI M-PHY® v5.0 physical layer specification and the MIPI UNIPRO® v2.0 transport layer specification.

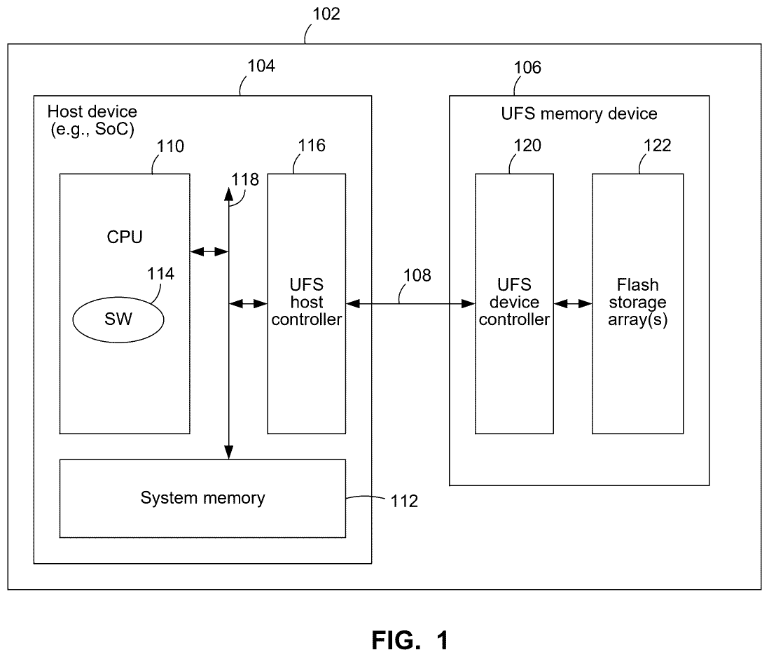

As shown in FIG. 1, in an illustrative or exemplary embodiment a system 102 may include a host device 104 and a UFS memory device 106. The system 102 may be, for example, a laptop or desktop computer, a mobile phone, a gaming device, an internet-of-things device, an automotive computing system, or any other type of computing device. The host device 104 may be, for example, a system-on-a-chip (“SoC”). The host device 104 and the UFS memory device 106 may be configured to communicate data over a UFS data communication link 108. Although in the illustrated example the UFS memory device 106 is contained within the system 102, such as co-located on a circuit board (not shown) with the host device 104, in other examples the UFS memory device 106 may be user-removable from the system 102.

The host device 104 may include a central processing unit (“CPU”) 110 or other processor. The host device 104 may also include one or more memories, such as a system memory 112. The system memory 112 may comprise, for example, dynamic random-access memory (“DRAM”). Nevertheless, in other examples the host device 104 may utilize the UFS memory device 106 as a system or main memory. Although in the illustrated example the system memory 112 is included in the host device 104 (e.g., SoC), in other examples such a system or main memory could be external to the SoC or other host device. The CPU 110 may be configured to operate in accordance with host software (“SW”) 114. Such host software 114 may include not only application-level software but also device drivers (not separately shown) and other software. The term “software,” as used herein, may also encompass firmware. Also, although in FIG. 1 the host software 114 is conceptually shown in the CPU 110 for purposes of clarity, such software may be executed from the system memory 112 or other memory in accordance with conventional computing principles.

The host device 104 may also include a UFS host controller 116. The CPU 110, system memory 112, UFS host controller 116, and other components (not shown) of the host device 104 may communicate with each other over one or more buses or other data interconnects 118. The UFS host controller 114 may be configured to control communication of data and commands between the CPU 110 (or other processors) and the UFS memory device 106 in a manner that enables the CPU 110, under control of the host software 114, to initiate memory transactions with the UFS memory device 106, including writing data to the UFS memory device 106 and reading data from the UFS memory device 106.

The UFS memory device 106 may include a UFS device controller 120 and one or more flash storage arrays 122 (i.e., arrays of data storage cells). The UFS host controller 116 and UFS device controller 120 may be structured as follows.

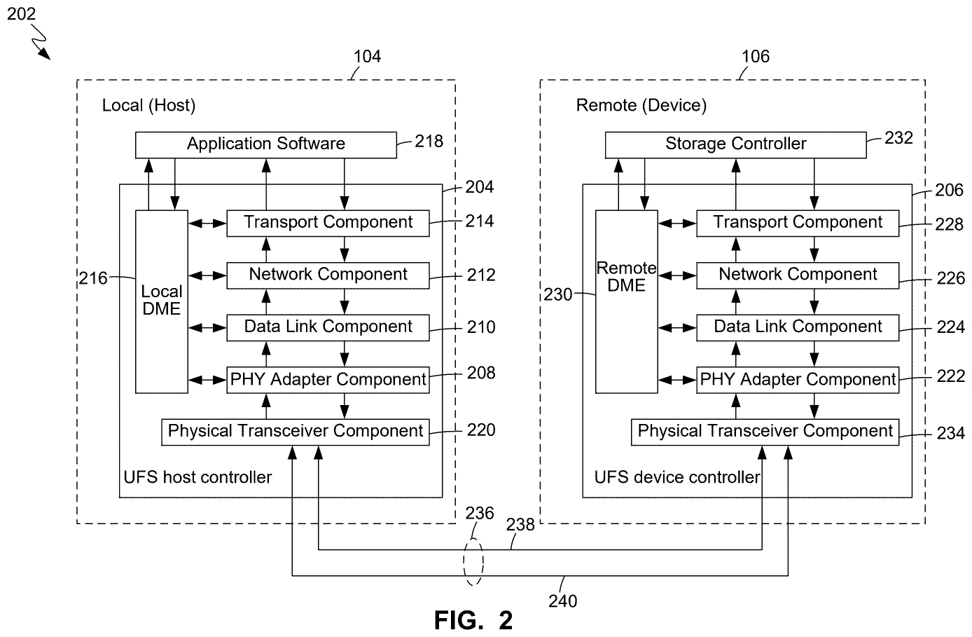

As shown in FIG. 2, a system 202 may include a UFS host controller 204 and UFS device controller 206. The UFS host controller 204 and UFS device controller 206 may be examples of the above-described UFS host controller 116 and UFS device controller 120 (FIG. 1). Components of the system 202 that are located in the host device 104 may be referred to herein for convenience as “local,” while components of the system 202 that are located in the UFS memory device 106 may be referred to as “remote.”

The UFS host controller 204 may include the following layers or components: a local physical adapter (“PA”) layer or component 208; a local data link layer or component 210; a local network layer or component 212; and a local transport layer or component 214. The UFS host controller 204 may also include a local device management entity (“DME”) 216 that configures or otherwise controls the layers or components 208-214. The local transport layer or component 214 may be configured to communicate with application-level host software 218, which may be an example of the above-described (FIG. 1) host software 114. The UFS host controller 204 may further include a local physical transceiver component 220, such as transmit ports, receive ports, and other circuitry (not individually shown for purposes of clarity).

The layers or components 208-214 and DME 216 may be configured as proposed by MIPI UNIPRO®, for example. The local PA layer or component 208 may be an example of a MIPI M-PHY®.

The UFS device controller 206 may include the following layers or components: a remote PA layer or component 222; a remote data link layer or component 224; a remote network layer or component 226; and a remote transport layer or component 228. The UFS device controller 206 may also include a remote DME 230 that configures or otherwise controls the layers or components 222-228. The remote transport layer or component 214 may be configured to communicate with a storage controller 232. The storage controller 232 may be coupled to flash storage media (not shown in FIG. 2), such as the flash storage arrays 122 described above with regard to FIG. 1. The UFS device controller 206 may further include a remote physical transceiver component 234, such as transmit ports, receive ports, and other circuitry (not individually shown for purposes of clarity).

The layers or components 222-228 and DME 230 may be configured as proposed by MIPI UNIPRO®, for example. The remote PA layer or component 222 may be an example of a MIPI M-PHY® layer or component.

The local physical transceiver component 220 and remote physical transceiver component 234 may be coupled to respective ends of a UFS data communication link 236, which may be an example of the above-described UFS data communication link 108 (FIG. 1). The UFS data communication link 236 may include two lanes 238 and 240. Each lane 238 and 240 may comprise a transmit differential pair of signal paths and a receive differential pair of signal paths (also sometimes referred to as forward link and reverse link, respectively), but such signal paths (e.g., wires or other conductors) are not individually shown for purposes of clarity.

Commands, responses, requests, data, etc., may be communicated over the data communication link 236 in the form of a packet known as a UFS Protocol Information Unit (“UPIU”). There are different types of UPIUs, each of which includes a header portion having various fields, followed by additional portions that may be used to contain data or other information, depending on the type of UPIU.

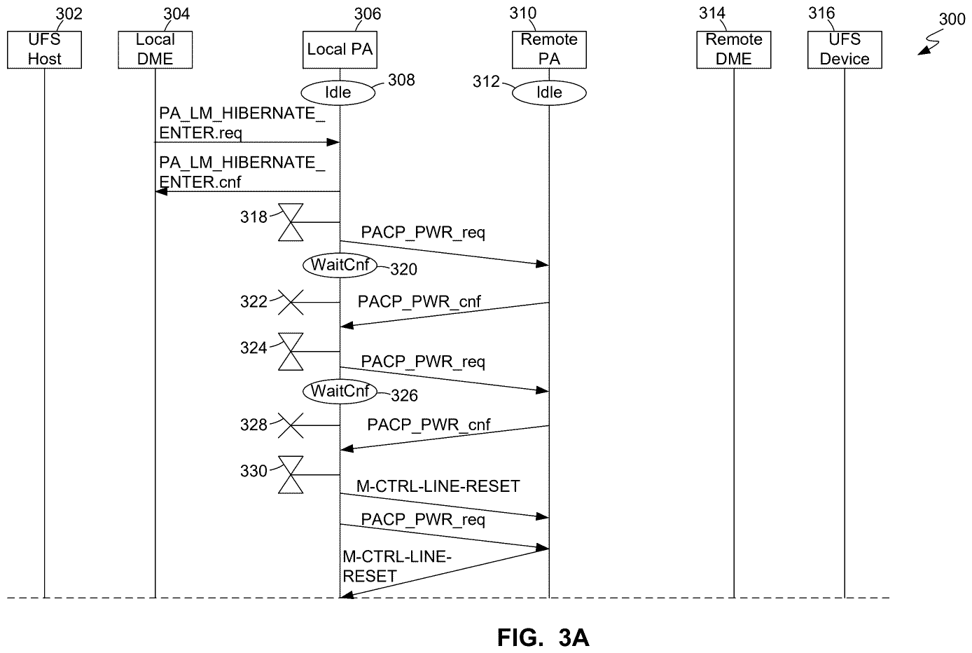

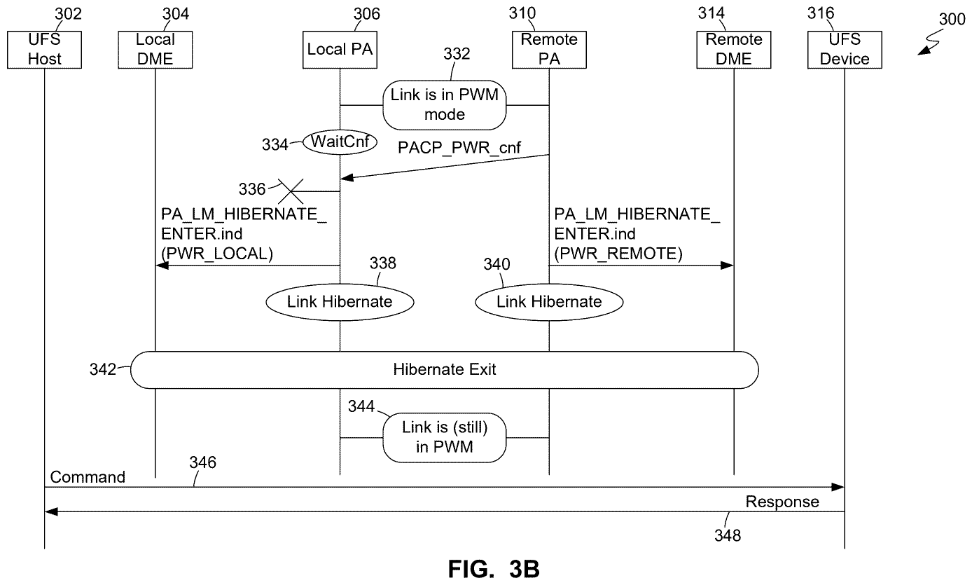

In FIGS. 3A-3B, a data communication diagram 300 illustrates a problem in the art that is addressed by the exemplary embodiments described herein. The problem may arise when a line reset occurs when a UFS device is entering into a low-power mode, such as the hibernate mode. (Other low-power modes are known, but hibernate may be the deepest low-power mode, consuming less power than other low-power modes.) Entry into, and exit from, the hibernate mode may occur automatically, i.e., independently of, and without input from, the UFS host 302. The UFS host 302 may be a processor executing an example of the above-described application-level host software 218 (FIG. 2). Such entry into, and exit from, a hibernate mode may be referred to as auto-hibernate. Auto-hibernate may be controlled by hardware (e.g., finite state machine, etc.) in the local DME 304. When the local DME 304 has remained idle for a predetermined time interval, the local DME 304 may send a request (“PA_LM_HIBERNATE_ENTER.req”) to enter the hibernate mode to the local PA 306, which may also be in an idle state 308 when it receives the request. The local DME 304 and local PA 306 may be examples of the above-described local DME 216 and local PA layer or component 208 (FIG. 2), respectively.

Although not shown in FIGS. 3A-3B, prior to the period of idleness that precipitated entry into the hibernate mode the UFS host 302 and a UFS device 316 may have been conducting data transactions, such as reading data from the UFS device 316 and writing data to the UFS device 316. The data communication link may have been configured in a high-speed (and, generally, correspondingly high-power) mode, such as, for example, any of HS-G1 to HS-G5, or other high-speed mode.

In response to the request to enter the hibernate mode, the local PA 306 may send a confirmation (“PA_LM_HIBERNATE_ENTER.cnf”) of the request back to the local DME 304. The local PA 306 may then initiate communication with a remote PA 310, which may be in an idle state 312, to place the communication link (not explicitly shown) between the local PA 306 and remote PA 310 into a low-power state associated with the hibernate mode. The remote PA 310 and a remote DME 314 may be examples of the above-described remote PA layer or component 222 and remote DME 230 (FIG. 2), respectively. The above-described storage controller 232 (FIG. 2) may be an example of the UFS device 316.

Placing the communication link in the hibernate mode may include the local PA 306 and the remote PA 310 reconfiguring circuitry to consume less power. When the communication link is in the hibernate mode, no data transactions may be performed between the UFS host 302 and the UFS device 316.

The local PA 306 may set a PA control protocol (“PACP”) request timer 318 and then send a power mode change request (“PACP_PWR_req”) to the remote PA 310 over the data communication link. In the illustrated example, this power mode change request is to request that the communication link power mode be changed to the power level associated with the hibernate mode. The local PA 306 may then remain in a waiting-for-confirmation (“WaitCnf”) state 320 while it awaits confirmation of the power mode change request. In response to the power mode change request, the remote PA 310 may disable or power down link-related circuitry as described above, and then send a power mode change confirmation (“PACP_PWR_cnf”) to the local PA 306 over the data communication link. In the example illustrated in FIGS. 3A-3B, a timer expiration 322 (of the above-referenced timer 318) occurs before the local PA 306 receives the power mode change confirmation (“PACP_PWR_cnf”). The timer expiration 322 occurring before the local PA 306 receives the power mode change confirmation indicates to the local PA 306 that the local PA 306 cannot confirm that the remote PA 310 has reconfigured the relevant link-related circuitry to operate in accordance with the requested power mode, which in the illustrated example is the hibernate mode. The timer expiration 322 occurring before the local PA 306 receives the power mode change confirmation may be referred to as a failure to change the communication link power mode. Such a power mode change failure may have various causes, including transient anomalies involving communication link circuitry.

Because the power mode change request failed in the illustrated example, the local PA 306 may re-try changing the communication link power mode. That is, the local PA 306 may again set a PACP request timer 324 and send a power mode change request to the remote PA 310 over the communication link. The local PA 306 may then remain in the waiting-for-confirmation state 326. In response to this re-try (or second power mode change request), the remote PA 310 may again send a power mode change confirmation to the local PA 306 over the communication link. In the illustrated example, a timer expiration 328 (of the above-referenced timer 324) again occurs before the local PA 306 receives the power mode change confirmation. That is, in example illustrated in FIGS. 3A-3B, like the first request to change the power mode, this re-try or second request to change the power mode has also failed.

Because the second power mode change request failed in the illustrated example, the local PA 306 may again re-try changing the communication link power mode. That is, the local PA 306 may again set a PACP request timer 330, but before sending another power mode change request to the remote PA 310, the local PA 306 may send a line reset (“M-CTRL-LINE-RESET”) to the remote PA 310. In response to receiving the line reset, the remote PA 310 may reset various logic circuitry and also send a line reset back to the local PA 306. That is, the local PA 306 and remote PA 310 may exchange line resets with each other.

Continuing on FIG. 3B, the exchange of line resets (i.e., the resetting of circuitry in response to one or both line resets) may reset the speed mode of the data communication link to a default mode, such as, for example, a pulse-width modulation (“PWM”) mode 332 that supports only low-speed signaling. (In contrast, high-speed modes may employ, for example, non-return-to-zero or “NRZ” signaling on the data communication link.) Note that the PWM mode 332 or other default speed mode may be lower speed than the mode in which the UFS host 302 and UFS device 316 may have been conducting data transactions prior to the period of idleness that precipitated entry into the hibernate mode.

In response to this second re-try (or third power mode change request), the remote PA 310 may send a power mode change confirmation to the local PA 306 while the local PA 306 is in the waiting-for-confirmation state 334. The exchange of line resets in the illustrated example may possibly rectify some condition that caused the power mode change failures, enabling the local PA 306 to successfully receive the power mode change confirmation before the timer expiration 336 (of the above-referenced timer 330) occurs. That is, in example illustrated in FIGS. 3A-3B, unlike the first request to change the power mode and the first re-try (or second request) to change the power mode, this second re-try (or third request) to change the power mode succeeds. That is, receipt of the power mode change confirmation before the timer expiration 336 indicates to the local PA 306 that the power mode change has succeeded.

Accordingly, the local PA 306 may send an indication (“PA_LM_HIBERNATE_ENTER.ind(PWR_LOCAL”) to the local DME 304, indicating that the power mode change has succeeded. Likewise, the remote PA 310 may send a similar indication (“PA_LM_HIBERNATE_ENTER.ind(PWR_REMOTE”) to the remote DME 314, indicating that the power mode change has succeeded. At this point in the illustrated example, the local PA 306 and the remote PA 310 are in respective link hibernate states 338 and 340.

Although not shown in FIG. 3B for purposes of clarity, a condition may occur that wakes the local PA 306 and the remote PA 310 from the link hibernate states 338 and 340. The hibernate exit 342 may include various communications among the local DME 304, local PA 306, remote PA 310, and remote DME 314. The hibernate exit 342 may be similar to the auto-hibernate entry described above in that the hibernate exit 342 may occur independently of, and without input from, the UFS host 302.

Note that when the hibernate exit 342 has completed, the local PA 306 and remote PA 310 are still in the PWM mode 344 or other default link speed mode that resulted from the exchange of line resets, as described above. In the illustrated example, after the hibernate exit 342 the UFS host 302 may initiate a transaction with the UFS device 316, such as reading data from the UFS device 316, writing data to the UFS device 316, etc. When the UFS host 302 sends the next command 346 (e.g., to initiate a transaction) after the hibernate exit 342, that command 346, the response 348 to that command that the UFS device 316 may send, and any other further communications over the data communication link, such as a data transmission, may be performed at the low speed of the PWM mode 344. (For purposes of clarity in FIG. 3B, the command 346 and response 348 are shown directly between the UFS host 302 and UFS device 316, omitting communications through intermediary components.) Nevertheless, it may be desirable to transmit data over the data communication link at a higher speed (i.e., in a higher-speed mode), such as a high-speed mode in which the UFS host 302 and UFS device 316 may have been communicating data before the hibernate entry. The UFS host 302, however, may be unaware that the data link speed mode has been reset to a default (e.g., PWM) as a result of the exchange of line resets, because there may be no conventional method by which the UFS host 302 can determine that a line reset occurred during an auto-hibernate entry.

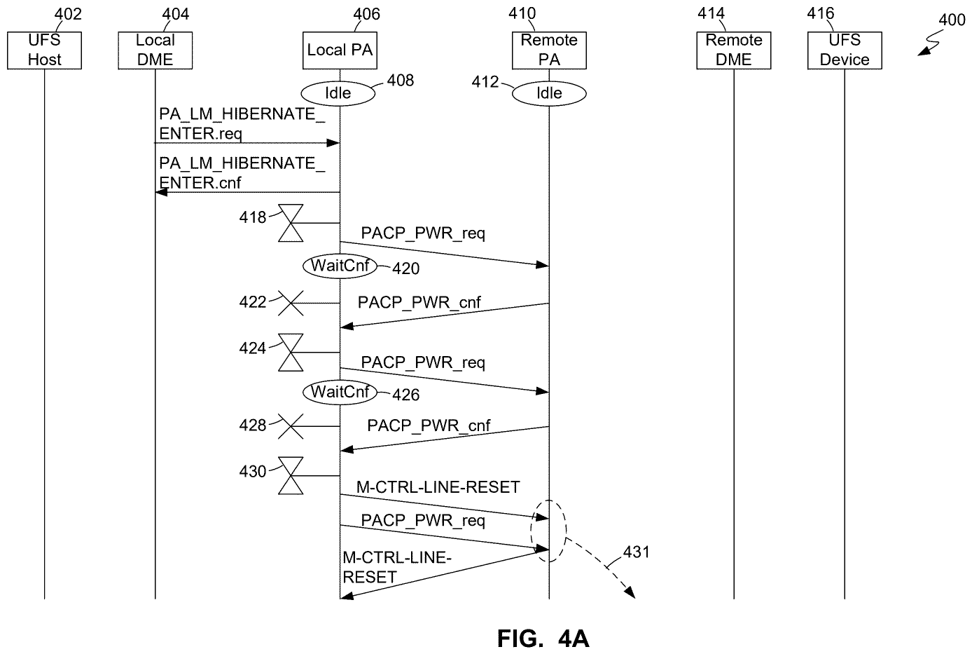

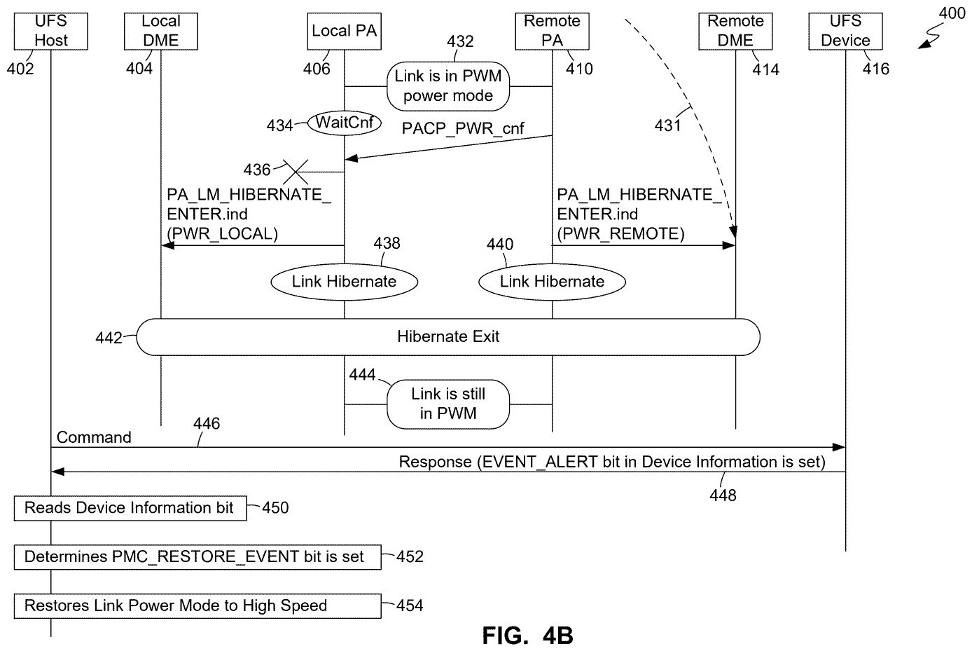

In FIGS. 4A-4B, a data communication diagram 400 illustrates an example of a solution to the above-described problem of a line reset occurring during an auto-hibernate entry. A UFS host 402 may be similar to the above-described UFS host 302 (FIGS. 3A-3B) except that the UFS host 402 may be additionally configured in a manner described below. A local DME 404 and local PA 406 may be similar to the above-described local DME 304 and local PA 306, respectively (FIGS. 3A-3B). A remote PA 410 may be similar to the above-described remote PA 310, except that the remote PA 410 may be additionally configured in a manner described below. A remote DME 414 and a UFS device 416 may be similar to the above-described remote DME 314 and UFS device 316, respectively (FIGS. 3A-3B), except that the remote DME 414 and UFS device 416 may be additionally configured in a manner described below.

As the communications shown in FIG. 4A may be similar to the communications described above with regard to FIG. 3A, they are not described in similar detail here. Briefly, it may be noted that while the local PA 406 is in an idle state 408 and the remote PA 410 is in an idle state 412, the local DME 404 may send a hibernate entry request to the local PA 406, which may return a hibernate entry request confirmation to the local DME 404. Then, the local PA 406 may set a timer 418, and send a power mode change request to the remote PA 410. While the local PA 406 is in a waiting-for-confirmation state 420, a timer expiration 422 occurs. The local PA 406 then again sets a timer 424 and retries the power mode change request. Again, while in a waiting-for-confirmation state 426, a timer expiration 428 occurs. The local PA 406 then attempts a second re-try, setting a timer 430, but before sending a third power mode change request, sends a line reset to the remote PA 410, which sends a line reset back to the local PA 406.

The remote PA 410 may be additionally configured to detect that this exchange of line resets occurred when the remote PA 410 received a power mode change request. The remote PA 410 may provide an indication 431 when the remote PA 410 receives both a power mode change request and a line reset (or participates in an exchange of line resets) and enters into the requested power mode.

Continuing in FIG. 4B, the exchange of line resets may reset the speed mode of the data communication link to a default mode, such as, for example, the PWM mode 432. In response to this second re-try, the remote PA 410 may send a power mode change confirmation to the local PA 406 while the local PA 406 is in the waiting-for-confirmation state 434. Receipt of the power mode change confirmation before the timer expiration 436 indicates to the local PA 406 that the power mode change has succeeded. Accordingly, the local PA 406 may send an indication (“PA_LM_HIBERNATE_ENTER.ind(PWR_LOCAL”) to the local DME 404, indicating that the power mode change has succeeded. Likewise, the remote PA 410 may send a similar indication (“PA_LM_HIBERNATE_ENTER.ind(PWR_REMOTE”) to the remote DME 414, indicating that the power mode change has succeeded. At this point in the illustrated example, the local PA 406 and the remote PA 410 are in respective link hibernate states 438 and 440.

The remote DME 414 may be additionally configured to receive or otherwise detect the above-described indication 431 produced by the remote PA 410. In response to detecting the indication 431 and the indication that the power mode change has succeeded (“PA_LM_HIBERNATE_ENTER.ind(PWR_REMOTE”), the remote DME 414 may be further configured to send an instruction to the UFS device 416 to set a PMC RESTORE EVENT attribute bit, which is described below. The UFS device 416 may be additionally configured to set this attribute bit when it is instructed by the remote DME 414. This attribute bit may be read by the UFS host 402 when an exception event occurs. A description of the remainder of FIG. 4B follows a description of this attribute bit and exception event.

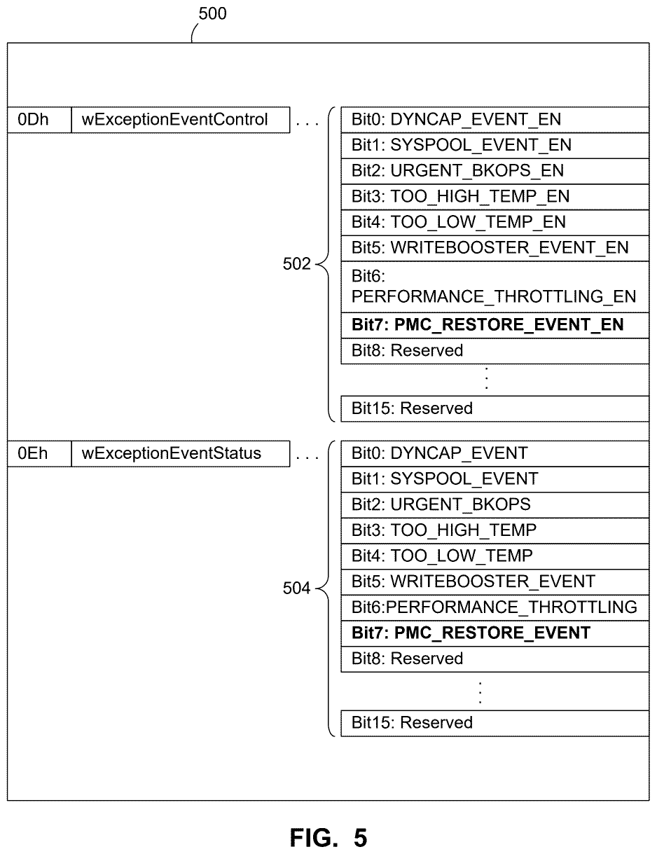

With reference to FIG. 5, a portion of a UFS attribute table 500 indicates two aspects of a UFS exception event mechanism: a control attribute 502 and a status attribute 504. The control attribute 502 may consist of, for example, 16 bits (“Bit0”-“Bit15”). The control attribute 502 may be referred to by the attribute name “wExceptionEventControl” and may have an attribute number of 0Dh (where the “h” indicates hexadecimal notation). The status attribute 504 similarly may consist of, for example, 16 bits (“Bit 0”-“Bit15”). The status attribute 504 may be referred to by the name “wExceptionEventStatus” and may have an attribute number of 0Eh. The UFS attribute table 500 may include further features of the attributes 502 and 504, such as an access property, a size, a type, and a default value, but such other features are not relevant to the solutions described herein and are not shown in FIG. 5 for purposes of clarity.

The bits of the control attribute 502 correspond to the bits of the status attribute 504 and indicate various conditions or events, such as, for example, abnormal operating conditions or “exceptions.” The UFS host 302 (FIG. 3A-3B) or 402 (FIGS. 4A-4B) may be configured to set selected bits of the control attribute 502 to indicate which of the exceptions or other conditions it is interested in being notified of. These conditions or events, as indicated by bits 0 through 6 of the status attribute 504, may include, respectively: DYNCAP_ NEEDED; SYSPOOL_EXHAUSTED; URGENT_BKOPS; TOO_HIGH_TEMPERATURE; TOO_LOW_TEMPERATURE; WRITEBOOSTER_ EVENT; and PERFORMANCE_THROTTLING. These conditions or events that are indicated by attribute bits 0 through 6 are not relevant to the solutions described herein. In addition to such conventional conditions or events, the solutions described herein may include an additional condition or event: PMC RESTORE EVENT. The UFS host 402 (FIGS. 4A-4B) may set a bit, such as, for example, Bit7, of the control attribute 502 to indicate that the UFS host 402 may be notified of the event described above: a line reset occurring when a power mode change is requested.

The UFS device 416 (FIGS. 4A-4B) may be configured to detect the above-described conditions or events and to set the corresponding bits of the status attribute 504 to indicate when the conditions or events are detected. Accordingly, when the UFS device 416 receives (as described above with regard to FIG. 4B) the instruction to set the PMC RESTORE EVENT bit, the UFS device 416 may set Bit7 of the status attribute 504.

In addition to the control attribute 502 and the status attribute 504, another aspect of the UFS exception event mechanism is an EVENT_ALERT flag. The EVENT_ALERT flag may be a bit in the Device Information field of a response UPIU header (not shown). The UFS device 416 sets this exception event alert flag bit when at least one of the bits of the status attribute 504 is set, thereby indicating the occurrence of the exception event associated with that bit, and a corresponding bit of the control attribute 502 is set, thereby indicating the UFS host's interest in being notified of that particular exception event.

For example, with reference again to FIG. 4B, following the hibernate exit 442, when the communication link is still in the PWM mode 444, the UFS host 402 may send a command 446 to the UFS device 416. In response to this next command following the hibernate exit 442, the UFS device 416 may send a response 448. When the UFS host 402 has set Bit7 of the control attribute 502 to indicate that the UFS host 402 is to be notified of the PMC_RESTORE_EVENT, and the UFS device 416 subsequently sets Bit7 of the status attribute 504 to indicate that the PMC_RESTORE_EVENT occurred, the UFS device 416 sets the EVENT_ALERT bit in the Device Information field of the response 448 (i.e., the response to the first command 446 following the hibernate exit 442).

For purposes of clarity in FIG. 4B, three further actions by the UFS host 402 are indicated in a flow diagram-like format by blocks 450, 452 and 454. The actions indicated by blocks 450-452 may be controlled by a host processor (e.g., the CPU 110 in FIG. 1) as configured by software in execution. As indicated by block 450, the UFS host 402 may read the Device Information field of the response 448 UPIU to determine whether the EVENT_ALERT bit is set.

As indicated by block 452, when the UFS host 402 has determined that the EVENT ALERT bit is set, the UFS host 402 may then read the control attribute 502 and the alert attribute 504 to determine which one or more of the above-described conditions or events occurred that caused the EVENT_ALERT bit to be set,. The UFS host 402 may determine that because Bit7 is set in the control attribute 502 and the alert attribute 504 in this example, the PMC_RESTORE_EVENT occurred.

As indicated by block 454, because the UFS host 402 determines in this example that the PMC_RESTORE_EVENT occurred, the UFS host 402 may change the data communication link power mode to a high-speed mode, such as, for example, restore the data communication link to the same high-speed mode in which the UFS host 402 was conducting transactions with the UFS device 416 before the auto-hibernate entry. Details of such a request by the UFS host 402 to change the power mode are not shown in FIG. 4B.

Absent the above-described solution, the UFS host 402 may not be informed following the hibernate mode exit that the data communication link power mode had been changed to a low-power, low-speed mode (e.g., PWM). As a result of not being informed of the reduction in the power/speed mode, transactions between the UFS host 402 and the UFS device 416 may continue at a lower speed than the speed at which such transactions had been conducted before the hibernate mode entry.

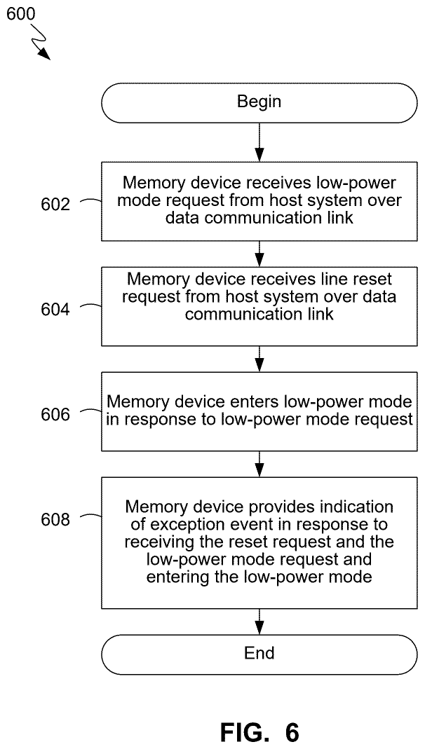

In FIG. 6, a method 600 for mitigating an effect of a line reset in a memory system is shown in flow diagram format. The method 600 relates to actions performed or controlled by a memory device.

As indicated by block 602, the memory device may receive a low-power mode request from a host system over a data communication link. The memory device may be a UFS memory device, and the low-power mode may be a UFS hibernate mode. As indicated by block 604, the memory device may also receive a reset request from the host system over the data communication link. As indicated by block 606, the memory device may enter the low-power mode in response to the low-power mode request. Although not shown in FIG. 6, in some examples the memory device may exit the low-power mode at some time after entering the low-power mode.

In some examples, the line reset may set the speed at which the memory device is capable of communicating over the data communication link to a low speed. For example, the “low speed” may be lower than a speed (“high speed”) at which the memory device and the host system may have been communicating data with each other before entering the low-power mode.

As indicated by block 608, the memory device may provide an indication of an exception event in response to having received the reset request and the low-power mode request and having entered the low-power mode. The indication of the exception event may be provided to the host system.

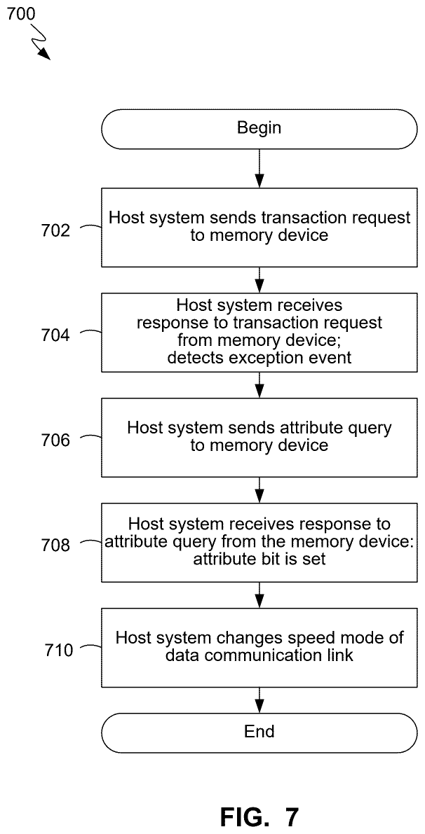

In FIG. 7, a method 700 for mitigating an effect of a line reset in a memory system is shown in flow diagram format. The method 700 relates to actions performed or controlled by a host system.

As indicated by block 702, the host system may send a transaction request (e.g., a command) to a memory device over a data communication link. The memory device may be a UFS memory device. As indicated by block 704, the host system may receive a response to the transaction request from the memory device. The response to the transaction request may indicate that an exception event has occurred. For example, a bit indicating an exception event has occurred may be set in a field of the response data packet.

As indicated by block 706, the host system, in response to detecting the exception event, may send a query to the memory device. As indicated by block 708, the host system may receive a response to the query from the memory device. The response to the query may indicate that the exception event is of a type relating to a line reset occurring during a power mode change. For example, a UFS attribute bit may be set that indicates such an exception event occurred.

As indicated by block 710, the host system, in response to determining that the exception event is the result of a line reset occurring during a power mode change of the data communication link, may change the speed mode of the data communication link. For example, the host system may restore the speed mode of the data communication link to a speed mode at which the host system and memory device may have been communicating data with each other at a time before the method 700 is performed.

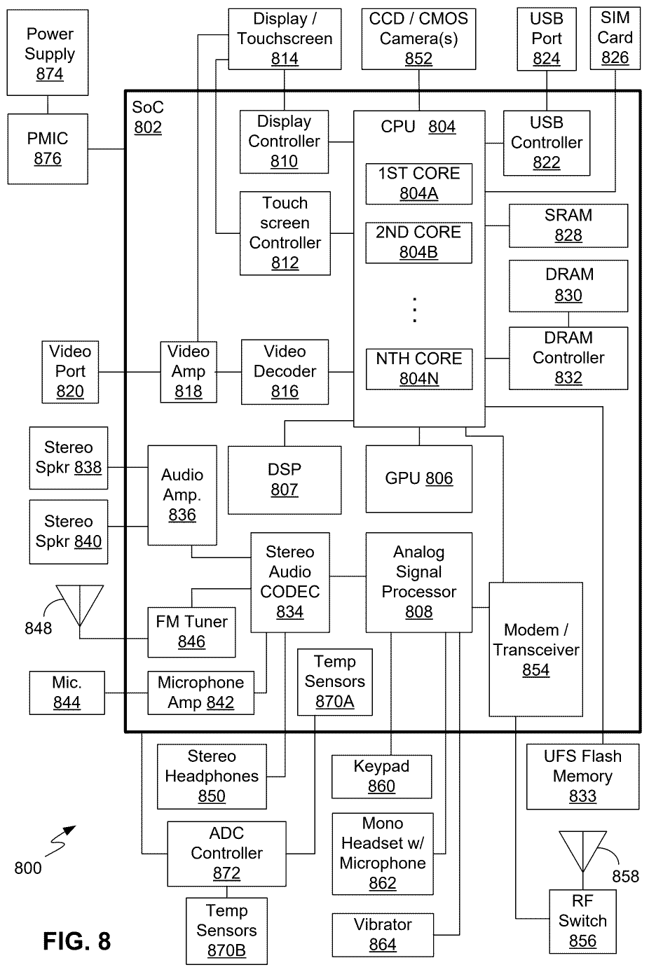

FIG. 8 illustrates an example of a portable computing device (“PCD”) 800, in which exemplary embodiments of systems, methods, computer-readable media, and other examples of mitigating an effect of a line reset in a memory system may be provided. The PCD 800 may be, for example, a cellular telephone or smartphone. For purposes of clarity, some data buses, interconnects, signals, etc., are not shown in FIG. 8.

The PCD 800 may include an SoC 802. The SoC 802 may include a CPU 804, a graphics processing unit (“GPU”) 806, a digital signal processor (“DSP”) 807, an analog signal processor 808, a modem/modem subsystem 854, or other processors. The CPU 804 may include one or more CPU cores, such as a first CPU core 804A, a second CPU core 804B, etc., through an Nth CPU core 804N.

A display controller 810 and a touch-screen controller 812 may be coupled to the CPU 804. A touchscreen display 814 external to the SoC 802 may be coupled to the display controller 810 and the touch-screen controller 812. The PCD 800 may further include a video decoder 816 coupled to the CPU 804. A video amplifier 818 may be coupled to the video decoder 816 and the touchscreen display 814. A video port 820 may be coupled to the video amplifier 818. A universal serial bus (“USB”) controller 822 may also be coupled to CPU 804, and a USB port 824 may be coupled to the USB controller 822. A subscriber identity module (“SIM”) card 826 may also be coupled to the CPU 804.

The CPU 804 may be coupled to one or more memories, with which the CPU 804 may initiate memory transactions. The one or more memories may include both volatile and non-volatile memories or NVMs. Examples of volatile memories include static random-access memory (“SRAM”) 828 and dynamic random-access memory (“DRAM”) 830. Such memories may be internal to the SoC 802, as in the illustrated embodiment, or alternatively, may be external to the SoC 802. A DRAM controller 832 coupled to the CPU 804 may control the writing of data to, and reading of data from, the DRAM 830.

The one or more memories may also include UFS memory device 833. The UFS memory device 833 may be an example of the above-described UFS memory device 106 (FIG. 1). Although the UFS memory device 833 is external to the SoC 802 in the illustrated example, in other examples such a UFS memory device may be included or “embedded” in such an SoC.

A stereo audio CODEC 834 may be coupled to the analog signal processor 808. Further, an audio amplifier 836 may be coupled to the stereo audio CODEC 834. First and second stereo speakers 838 and 840, respectively, may be coupled to the audio amplifier 836. In addition, a microphone amplifier 842 may be coupled to the stereo audio CODEC 834, and a microphone 844 may be coupled to the microphone amplifier 842. A frequency modulation (“FM”) radio tuner 846 may be coupled to the stereo audio CODEC 834. An FM antenna 848 may be coupled to the FM radio tuner 846. Further, stereo headphones 850 may be coupled to the stereo audio CODEC 834. Other devices that may be coupled to the CPU 804 include one or more digital (e.g., CCD or CMOS) cameras 852.

The modem or RF transceiver 854 may be coupled to the analog signal processor 808 and the CPU 804. An RF switch 856 may be coupled to the RF transceiver 854 and an RF antenna 858. In addition, a keypad 860, a mono headset with a microphone 862, and a vibrator device 864 may be coupled to the analog signal processor 808.

The SoC 802 may have one or more internal or on-chip thermal sensors 870A and may be coupled to one or more external or off-chip thermal sensors 870B. An analog-to-digital converter controller 872 may convert voltage drops produced by the thermal sensors 870A and 870B to digital signals. A power supply 874 and a power management integrated circuit (“PMIC”) 876 may supply power to the SoC 802.

Firmware or software may be stored in any of the above-described memories, such as the DRAM 830, the UFS flash memory 833, the SRAM 828, etc., or may be stored in a local memory directly accessible by the processor hardware on which the software or firmware executes. Execution of such firmware or software may control aspects of any of the above-described methods or configure aspects any of the above-described systems. Any such memory or other non-transitory storage medium having firmware or software stored therein in computer-readable form for execution by processor hardware may be an example of a “computer-readable medium,” as the term is understood in the patent lexicon.

Implementation examples are described in the following numbered clauses.
1. A method for mitigating an effect of a line reset in a memory system, comprising:
receiving, by a memory device, a low-power mode request from a host device over a data communication link between the memory device and the host device;
receiving, by the memory device, a reset request;
entering, by the memory device, the low-power mode in response to the low-power mode request; and
providing, by the memory device, an indication of an exception event in response to the memory device receiving the reset request and the low-power mode request and the memory device entering the low-power mode.
2. The method of clause 1, further comprising:
exiting, by the memory device, the low-power mode; and
changing, by the host device, a speed mode of the data communication link in response to the exception event.
3. The method of clause 1 or 2, wherein the memory device is Universal Flash System (UFS).
4. The method of any of clauses 1-3, wherein the low-power mode is a UFS hibernate mode.
5. The method of any of clauses 1-4, wherein providing the indication of the exception event comprises setting, by the memory device, a bit value in a UFS attribute.
6. The method of any of clauses 1-5, wherein providing the indication of the exception event further comprises:
receiving, by the memory device, a transaction request from the host device over the data communication link; and
sending, by the memory device, a response to the transaction request to the host device, the response to the transaction request including a flag indicating occurrence of the exception event.
7. The method of clause 5, further comprising:
receiving, by the memory device, a query from the host device; and
sending, by the memory device, a response to the query, the response to the query including the bit value in the UFS attribute.
8. The method of clause 7, further comprising changing, by the host device, a speed mode of the data communication link in response to the exception event.
9. A system for mitigating an effect of a line reset in a memory system, comprising:
a host device; and
a memory device, the memory device configured to:
receive a low-power mode request from the host device over a data communication link between the memory device and the host device;
receive a reset request from the host device;
enter the low-power mode in response to the low-power mode request; and
provide an indication of an exception event in response to the memory device receiving the reset request and the low-power mode request and the memory device entering the low-power mode.
10. The system of clause 9, wherein:
the memory device is further configured to exit the low-power mode; and host device is further configured to change a speed mode of the data communication link in response to the exception event.
11. The system of clause 9 or 10, wherein the memory device is Universal Flash System (UFS).
12. The system of any of clauses 9-11, wherein the low-power mode is a UFS hibernate mode.
13. The system of any of clauses 9-12, wherein the memory device is configured to provide the indication of the exception event by being configured to set a bit value in a UFS attribute.
14. The system of any of clauses 9-13, wherein the memory device is configured to provide the indication of the exception event by being configured to: receive a transaction request from the host device over the data communication link; and send a response to the transaction request to the host device, the response to the transaction request including a flag indicating occurrence of the exception event.
15. The system of clause 13, wherein the memory device is further configured to:
receive a query from the host device; and
send a response to the query, the response to the query including the bit value in the UFS attribute.
16. The system of clause 15, wherein the host device is further configured to change a speed mode of the data communication link in response to the exception event.
17. A system for mitigating an effect of a line reset in a memory system, comprising:
means for receiving a low-power mode request from a host device over a data communication link between a memory device and the host device;
means for receiving a reset request;
means for entering the low-power mode in response to the low-power mode request; and
means for providing an indication of an exception event in response to receiving the reset request and the low-power mode request and entering the low-power mode.
18. The system of clause 17, further comprising:
means for exiting the low-power mode; and
means for changing a speed mode of the data communication link in response to the exception event.
19. The system of clause 17 or 18, wherein the memory device is Universal Flash System (UFS).
20. The system of any of clauses 17-19, wherein the low-power mode is a UFS hibernate mode.
21. The system of any of clauses 17-20, wherein the means for providing the indication of the exception event comprises means for setting a bit value in a UFS attribute.
22. The system of any of clauses 17-21, wherein the means for providing the indication of the exception event further comprises:
means for receiving a transaction request from the host device over the data communication link; and
means for sending a response to the transaction request to the host device, the response to the transaction request including a flag indicating occurrence of the exception event.
23. The system of clause 21, further comprising:
means for receiving a query from the host device; and
means for sending a response to the query, the response to the query including the bit value in the UFS attribute.
24. The system of clause 23, further comprising means for changing a speed mode of the data communication link in response to the exception event.
25. A Universal Flash System (UFS) memory device, comprising:
a flash memory storage array; and
a UFS controller configured to:
receive a low-power mode request from the host device over a data communication link between the memory device and the host device;
receive a reset request from the host device;
enter the low-power mode in response to the low-power mode request; and
provide an indication of an exception event in response to the memory device receiving the reset request and the low-power mode request and the memory device entering the low-power mode.
26. The UFS memory device of clause 25, wherein the UFS memory device is further configured to:
exit the low-power mode; and
change a speed mode of the data communication link in response to the exception event.
27. The UFS memory device of clause 25 or 26, wherein the low-power mode is a UFS hibernate mode.
28. The UFS memory device of any of clauses 25-27, wherein the UFS memory device is configured to provide the indication of the exception event by being configured to set a bit value in a UFS attribute.
29. The UFS memory device of any of clauses 17-28, wherein the UFS memory device is configured to provide the indication of the exception event by being configured to:
receive a transaction request from the host device over the data communication link; and send a response to the transaction request to the host device, the response to the transaction request including a flag indicating occurrence of the exception event.
30. The UFS memory device of clause 28, wherein the UFS memory device is further configured to:
receive a query from the host device; and
send a response to the query, the response to the query including the bit value in the UFS attribute.

Alternative embodiments will become apparent to one of ordinary skill in the art to which the invention pertains. Therefore, although selected aspects have been illustrated and described in detail, it will be understood that various substitutions and alterations may be made therein.

1. A method for mitigating an effect of a line reset in a memory system, comprising:
receiving, by a memory device, a low-power mode request from a host device over a data communication link between the memory device and the host device;
receiving, by the memory device, a reset request;
entering, by the memory device, the low-power mode in response to the low-power mode request; and
providing, by the memory device, an indication of an exception event in response to the memory device receiving the reset request and the low-power mode request and the memory device entering the low-power mode.

2. The method of claim 1, further comprising:
exiting, by the memory device, the low-power mode; and
changing, by the host device, a speed mode of the data communication link in response to the exception event.

3. The method of claim 1, wherein the memory device is Universal Flash System (UFS).

4. The method of claim 3, wherein the low-power mode is a UFS hibernate mode.

5. The method of claim 3, wherein providing the indication of the exception event comprises setting, by the memory device, a bit value in a UFS attribute.

6. The method of claim 5, wherein providing the indication of the exception event further comprises:
receiving, by the memory device, a transaction request from the host device over the data communication link; and
sending, by the memory device, a response to the transaction request to the host device, the response to the transaction request including a flag indicating occurrence of the exception event.

7. The method of claim 6, further comprising:
receiving, by the memory device, a query from the host device; and
sending, by the memory device, a response to the query, the response to the query including the bit value in the UFS attribute.

8. (canceled)

9. A system for mitigating an effect of a line reset in a memory system, comprising:
a host device; and
a memory device, the memory device configured to:
receive a low-power mode request from the host device over a data communication link between the memory device and the host device;
receive a reset request from the host device;
enter the low-power mode in response to the low-power mode request; and
provide an indication of an exception event in response to the memory device receiving the reset request and the low-power mode request and the memory device entering the low-power mode.

10. The system of claim 9, wherein:
the memory device is further configured to exit the low-power mode; and
host device is further configured to change a speed mode of the data communication link in response to the exception event.

11. The system of claim 9, wherein the memory device is Universal Flash System (UFS).

12. The system of claim 11, wherein the low-power mode is a UFS hibernate mode.

13. The system of claim 11, wherein the memory device is configured to provide the indication of the exception event by being configured to set a bit value in a UFS attribute.

14. The system of claim 13, wherein the memory device is configured to provide the indication of the exception event by being configured to:
receive a transaction request from the host device over the data communication link; and
send a response to the transaction request to the host device, the response to the transaction request including a flag indicating occurrence of the exception event.

15. The system of claim 14, wherein the memory device is further configured to:
receive a query from the host device; and
send a response to the query, the response to the query including the bit value in the UFS attribute.

16-24. (canceled)

25. A Universal Flash System (UFS) memory device, comprising:
a flash memory storage array; and
a UFS controller configured to:
receive a low-power mode request from the host device over a data communication link between the memory device and the host device;
receive a reset request from the host device;
enter the low-power mode in response to the low-power mode request; and
provide an indication of an exception event in response to the memory device receiving the reset request and the low-power mode request and the memory device entering the low-power mode.

26. The UFS memory device of claim 25, wherein the UFS memory device is further configured to:
exit the low-power mode; and
change a speed mode of the data communication link in response to the exception event.

27. The UFS memory device of claim 26, wherein the low-power mode is a UFS hibernate mode.

28. The UFS memory device of claim 26, wherein the UFS memory device is configured to provide the indication of the exception event by being configured to set a bit value in a UFS attribute.

29. The UFS memory device of claim 28, wherein the UFS memory device is configured to provide the indication of the exception event by being configured to:
receive a transaction request from the host device over the data communication link; and
send a response to the transaction request to the host device, the response to the transaction request including a flag indicating occurrence of the exception event.

30. The UFS memory device of claim 29, wherein the UFS memory device is further configured to:
receive a query from the host device; and
send a response to the query, the response to the query including the bit value in the UFS attribute.
